(19) United States
(12) Patent Application Publication
(10) Pub. No.: US 2002/0082717 A1
(43) Pub. Date: Jun. 27, 2002

(54) Method and system for centralizing and harmonizing the operations of plural software license managers

(75) Inventors: Per Hellberg, New York, NY (US); Robert Barritz, New York, NY (US); David Vardi, New York, NY (US)

Correspondence Address: OSTROLENK FABER GERB & SOFFEN, 1180 AVENUE OF THE AMERICAS, NEW YORK, NY, 100368403

(73) Assignee: Isogon Corporation

(21) Appl. No.: 10/021,328

(22) Filed: Oct. 29, 2001

Related U.S. Application Data
(60) Provisional application No. 60/244,566, filed on Oct. 31, 2000.

(51) Int. Cl. G05B 19/18

(52) U.S. Cl. 700/3

(57) ABSTRACT

A method and system for centralizing and harmonizing the operation of plural software license managers operates in one embodiment thereof by providing a central license manager that replaces the plural license managers by duplicating and replicating their functionality in an manner that is transparent and automatic from the perspective of application programs which require and call for license certificates. In alternate embodiments of the invention, the invention comprises translation procedures that interface and harmonize API calls from application programs requesting license certificates and license certificate information obtained by the cental license manager.

### RELATED APPLICATION

This Application claims priority and is entitled to the filing date of U.S. Provisional Application Serial No. 60/244,566 filed Oct. 31, 2000, and entitled “METHOD AND SYSTEM FOR CENTRALIZING AND HARMONIZING THE OPERATIONS OF PLURAL SOFTWARE LICENSE MANAGERS”, the contents of which are incorporated by reference herein.

### BACKGROUND OF THE INVENTION

The present invention generally relates to software license managers and, more particularly, concerns a method and system that centralizes and/or harmonizes the operations of a plurality of software license managers.

Much of the software in use by corporations, organizations and individuals is licensed either directly or indirectly from a variety of software vendors. The rights granted the licensees may take a variety of forms. For example, a software product might be licensed to an organization for unlimited use, on any number of computers, but only within that organization. Or, the organization might be permitted to only use the software on certain computers, or allow it to be used by only certain named employees, or by only a specified maximum number of concurrent employees, or until a specified date, or only on certain days of the week, or based on any other set of restrictions that the vendor may negotiate with the organization.

In many cases, vendors have incorporated protective mechanisms (PMs) into their software products to try and determine whether the usage restrictions that are embodied in the license terms are ever violated in practice. For example, such a PM, which is typically invoked when the associated software product is initiated, might determine whether the computer (as identified by such things as a serial number or other unique characteristic) that the software is operating on is on the list of computers that the software is licensed to. Or, the PM might count the number of users concurrently using the software, checking to see whether a licensed maximum is ever exceeded.

If the PM detects attempted violations, a variety of actions may be taken, from issuing a warning while allowing execution, to preventing the software from operating.

For the PM to be able to match the actual use of a software product to the organization's licensed rights, the PM must know what those rights are. These are often supplied via an encrypted password or certificate which the software vendor gives to the organization, which in turn supplies it to the PM. Typically, a PM will not allow the software product to operate at all if a certificate is not supplied, missing, expired, or otherwise not made “known” to the PM.

While many vendors have developed their own protective mechanisms to enforce these rights, some use general purpose software supplied to them by other vendors. Such facilities, known as License Managers (LMs), are available from a variety of vendors, including Isogon (LicensePower/iFOR), Globetrotter (FLEXlm), IBM (LUM), and Rainbow (SentinelLM).

Typically, when a licensed software product begins its execution, it invokes the LM, perhaps using an Application Programming Interface (API) defined for this purpose by the vendor of the LM, and supplying identification information consisting of the identity of the software product, and possibly also version and/or feature information, providing for a more granular definition of what is being licensed. The LM determines if there exists a license certificate corresponding to the software product in question, and, if so, whether the licensed rights detailed in the certificate match the circumstances of use. If they do, a “clear-to-proceed” response is returned to the licensed software product. But if they do not—if, for example, the licensed software product is currently executing on a computer whose serial number is not defined in the certificate—the LM returns an “out-of-compliance” response to the licensed software product, which can take whatever action is deemed appropriate under that circumstance.

Similarly, the LM vendor may provide a management program or API that is used by applications which implement such functions as installing, updating, and deleting license certificates, and extracting usage data for reporting.

Although there may be many physical servers in a computer system, a licensed product may communicate with just a single, logical license server that is embodied in the API of the LM. The library of software composing the API on the local computer directs requests to a library on the physical server that then processes the request, oftentimes enforcing license rights for a product that may encompass multiple computers.

While LMs from different vendors share the general functionality described above, they differ from one another in a variety of ways, for example with regard to the particular set of functions supported by their API, or in the way in which the end-users supply certificates to the License Server or otherwise administer and operate the licensing system. If an end-user licenses two or more software products whose vendors have employed different LMs, the end-user will have to operate and administer multiple LM systems. For example, if an end-user licenses both ProductX, which requires the services of FLEXlm, and ProductY, which requires LUM, the end-user will have to install, operate and administer both FLEXlm and LUM. And if other products licensed by the end-user require LicensePower/iFOR and SentinelLM, these would have to be installed, operated and administered as well.

In March of 1999, an IT industry standard for LMs was approved by The Open Group. Known as XSLM, the standard is expected to encourage the development of XSLM-compliant LMs from several LM vendors. The existence of industry-standard LMs can in turn be expected to encourage more product vendors to employ an LM to control the licensed use of their product. Thus, many user organization operating one or more of the existing LMs find themselves obliged to operate an XSLM-compliant LM as well. This will occur as soon as they license a product, say ProductZ, that uses an XSLM-compliant LM.

As the XSLM standard establishes a set of minimum requirements to be compliant, some XSLM-compliant vendors may choose to provide additional services and capabilities from which some LMs may benefit. For example, one vendor may choose to provide enhanced license management facilities while another may choose to report activity of licensed products using a central clearinghouse such as described in the present assignee's U.S. Pat. No. 6,029,145, the contents of which are incorporated by reference herein.

Users find it burdensome to operate multiple LMs. Each LM has its own system management requirements, idiosyncratic characteristics, its own procedures to be learned by the user's personnel, its own bugs, quirks and defects. Moreover, each separate LM must be periodically updated or upgraded as bug-fixes or new releases of the LM are made available. Since LMs are critical elements in the user's computing environment (if an LM is inoperative, most, if not all, of the licensed products that rely on that particular LM will not operate at all), users must perform extensive testing of the LM (which also entails testing all the licensed products that use that LM) before bug-fixes or new releases can be used in a production environment.

In some situations, a vendor may choose to stop, for a variety of reasons, all further development and support of a product. Typically, such products become legacy products—older programs that are generally considered obsolete, that are no longer offered to the public, but are still in use. Users of such legacy products have no alternative but to continue using the ILM (Internal License Manager) to which these products have been instrumented.

The greater the number of LMs a user is obliged to operate, the greater the burden. In an ideal world (from the perspective of users), all vendors would use the same LM, preferably an industry-standard XSLM-compliant LM.

But vendors who have already chosen a particular LM for use with their products, and typically having paid a license fee to the LM vendor, and having modified the source code of their products to interact with the chosen LM through its particular API, are naturally reluctant to make further source code changes in order to convert to another LM. Still others may be reluctant to convert because unless all of their customers were to convert to a new LM, they would have to support multiple versions of their products.

### SUMMARY OF THE INVENTION

It is an object of the present invention to provide a system and method wherein software products instrumented for an LM such as LicensePower/iFor or FLEXlm (hereafter referred to as the Internal License Manager, or ILM) continue to use its ILM interface, but where an XSLM-compliant LM (hereinafter, referred to as XSLM) effects and performs the functionality of the ILM. Software products instrumented to use the ILM continue to operate transparently, with 100% functionality, with the XSLM providing license management services, and using normal XSLM license certificates.

The advantage of such a method is that vendors who have already instrumented their products for a particular ILM do not have to change or retest them. Users on the other hand may find it feasible to operate only a single LM as their XSLM, supporting not only those licensed products which utilize the XSLM directly, but also any licensed products which use an LM that has employed the method of this invention to use the functionality of the XSLM.

It is a further object of the present invention to provide a system and method wherein software products instrumented for an ILM use license certificates that have been generated for the XSLM.

It is a further object of the present invention to provide a system and method that enables an existing ILM to use license certificates that have been generated for an XSLM.

It is also an object of the present invention to provide a system and method that enables an existing ILM to continue to use its own license certificates while communicating various license usage data to an XSLM thereby enabling users to use XSLM tools to obtain license management information.

It is yet another object of the present invention to provide a system and method that enables an existing ILM to use an XSLM as a repository for ILM license certificates.

The foregoing and other objects of the invention are realized by a method and system which provides various translators that translate and/or create substitutes for different commands and results obtained from license managers, to achieve compatibility and centralization of function, so that license monitoring and controlling becomes more streamlined and less prone to constant changing and revising.

In one embodiment thereof, the invention comprises a software license management system that includes a plurality of application programs that operate with a plurality of license certificates that authorize use of the application programs. The application programs use various protocols to request license authorization. The protocols used by the application programs correspond and are associated with one or more of predetermined license managers. In the present invention, a central license manager replaces the one or more predetermined license managers and is operable for intervening and acting for the predetermined license managers to obtain the license certificates for the applications programs, transparently to the application programs. The central license manager can operate by intercepting API calls, normally associated with the application program, which is accomplished by hooking, renaming modules, executing exit routines and the like.

In other forms of the invention, the system uses both the predetermined license managers using the conventional protocols recognized by the application programs, as well as the central license manager, which can serve as a repository for license information and data and can also implement part or a substantial portion of the functionality normally carried out or provided by the conventional predetermined license managers that execute the conventional protocols.

As another alternative, the invention provides a license certificate translator and enables the central license manager to translate license certificate formats to be compatible to either the predetermined license managers or to license certificate formats normally associated with a central license manager.

Other features and advantages of the present invention will become apparent from the following description of the invention which refers to the accompanying drawings.

### BRIEF DESCRIPTION OF THE DRAWINGS

FIG. 1 is a diagram of a prior art mode of obtaining software license certificates.

FIG. 1A is a diagram of a first concept of the present invention.

FIG. 1B is a flow chart which relates to the embodiment of FIG. 1A.

FIG. 1C is a further diagram of the concept of the present invention.

FIG. 2 is a block diagram of a license certificate translator concept of the present invention.

FIG. 2A is a flow chart that depicts operation by a native ILM simultaneously with an XSLM license manager.

FIG. 3 is a diagram of another embodiment of the present invention.

FIG. 3A is a flow chart which relates to FIG. 3.

FIG. 4 depicts an operation in which an internal license manager uses a standardized license manager to obtain its license certificates.

### DETAILED DESCRIPTION OF EMBODIMENTS OF THE INVENTION

The term “intercept” means the ability to alter the flow of control of an existing program or operating system in a transparent manner in order to perform a prescribed operation and then return control back to the intercept point and continue processing as though, as far as the existing program or operating system, nothing has happened. Typically, techniques for introducing, or “hooking”, an additional set of instructions into an existing program or operating system are familiar to those skilled in the art. These may include techniques such as renaming an existing module and substituting a module with the original name or dynamically changing an address vector to point to the new program, retaining the address of the original program so it can be invoked after the new program competes its operations. Another type of intercept is an “exit” which represents a point in a software product at which a user exit routine may be given control to change or extend the functions of the software product at user-specified events. Exit routines are written to replace one or more existing modules of a software product, or are added to a software product as one or more modules or subroutines. While hooking is provided unbeknownst to the hooked application, exit routines are expected to be used and their interactions with the application is expected to follow certain rules defined by the application.

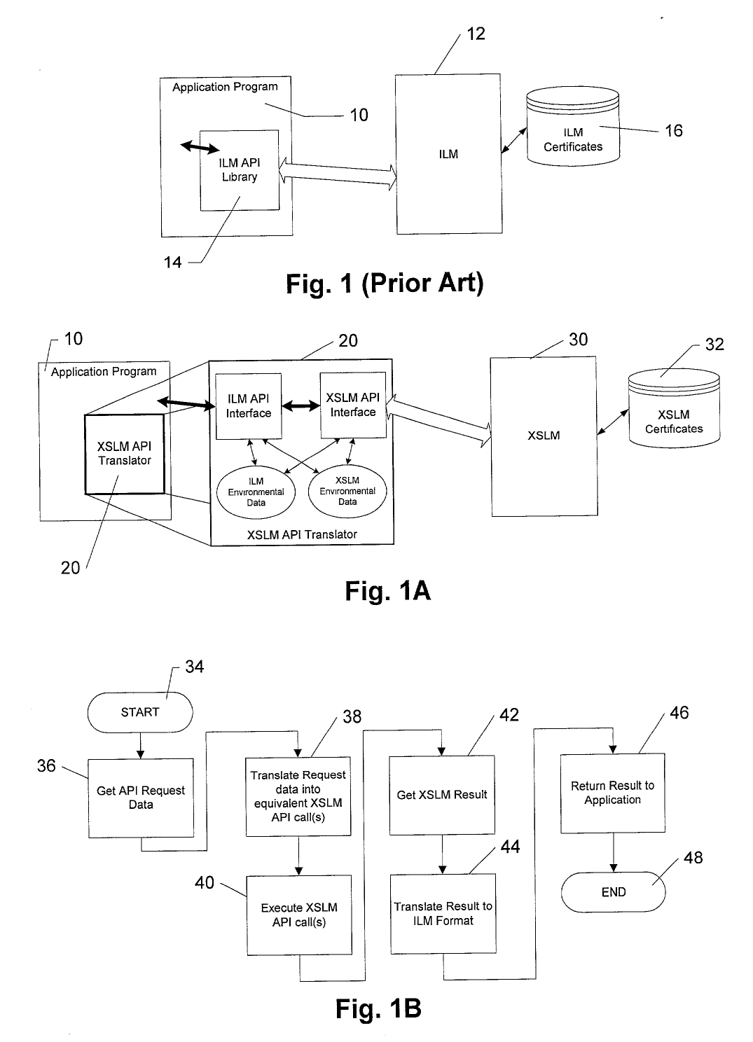

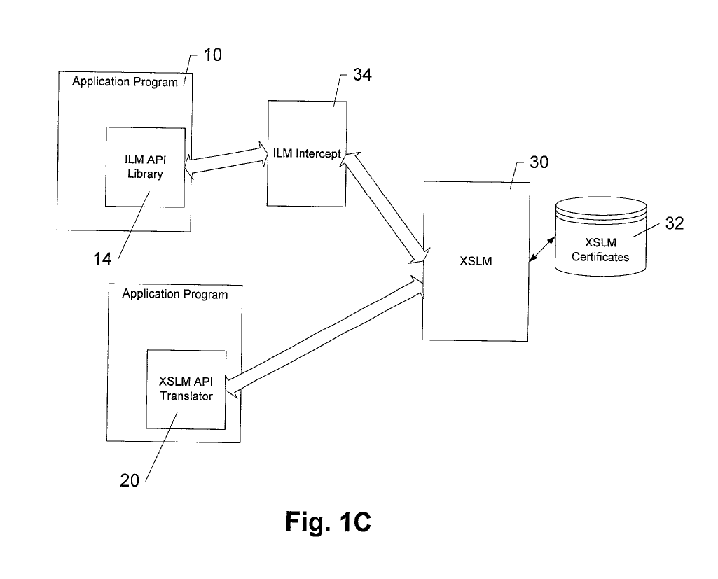

Software vendors instrument their product, e.g., application program 10, to a particular ILM 12 using a library 14 of API calls and software provided by LM vendors, that is linked with software applications to interface with the ILM 12 that can receive ILM certificates 16, as shown in FIG. 1. In some circumstances, the API library 14 is linked as a shared runtime library or executing agent process and, in others, the actual library code is linked directly into the application program. While some of the processing is performed in the API library, an ILM server process completes processing license requests for the application program and others that it administers.

In one embodiment (FIG. 1A), a library of software (collectively, the XSLM Translator 20) bearing the same procedure names (entry points) as the original ILM-API, but which accepts the application's license request calls and translates them into the appropriate XSLM-style calls, is linked with the software application 10. Thus, while the software application still issues original ILM API license request calls, each call is translated by the new linked module into the appropriate XSLM-style API calls. (FIG. 1A and FIG. 1B show the processing within the XSLM API Translator). Conversely, any data (including license certificate data) and status received as a result of an API call to the XSLM 30 is translated back into a format that is compatible with the ILM-API. As a result, the need for the ILM has been completely eliminated as the software application communicates its license requests via the replacement modules directly to the XSLM and using normal XSLM license certificates 32.

In the case where the ILM API library 14 is provided as a shared runtime library or executing agent process, the XSLM translator 20 replaces the ILM library with its own shared runtime library or agent process, respectively. In other cases, the individual software vendor links the XSLM translator library with its application programs, distributing them to its customers.

For example, an application using the LicensePower/iFor ILM might make an API call to the procedure “netls_extended_request_license( )”. An application using the FLEXlm ILM would make an API call to “lc_checkout( )”. The replacement procedure having the same name [netls_extended_request_license( ) or lc_checkout( )]translates the calling arguments, as appropriate, into the format required by the XSLM API call, which in this instance, is “xslm_basic_request_license( )”. The XSLM API call is made and the results are translated back into the format used by the ILM API and those results returned to the calling application.

It should be noted that a single ILM API call may require multiple XSLM API calls to perform the desired request and vice versa. In some instances, several ILM API calls may be required to provide all the data necessary for a single XSLM API call to perform the license request and, may possibly require that various data elements not only be retained in temporary storage but that the current status (“ok”, “incomplete”, “missing”, etc.) of those elements also be tracked. Furthermore, the data provided by the ILM API call may not provide the proper information, in either content or format, for the XSLM API calls. Conversely, the data returned by the XSLM may not compatible in either content or format with the ILM. For example, the length of a text string returned by the XSLM may be of different size than that used by the ILM, possibly resulting in a program error.

For each API call, the XSLM Translator performs the necessary translations in both number and type of API calls between the ILM and XSLM, providing the data in both the appropriate format and content. In the latter instance, augmentation of the data is performed to provide data to both ILM 12 and XSLM 30 API calls in the proper content and format. Some of the means by which translator accomplishes this are by

Providing temporary data elements, if necessary, to contain translated data for use in API calls

Providing data elements (tables, lists, files, etc.) to retain relevant data elements (ILM, XSLM or both) and their status across multiple API calls

Providing conversion tables between data variables such as option codes, error codes, function codes, etc.

Using aliases (for file names, etc.) as a means for the ILM or XSLM to reference the same data in those cases wherein the respective formats are different (e.g., the length of a text string).

Optionally, the XSLM Translator uses XSLM license certificates to store the temporary and augmented data variables.

Collectively, the XSLM data translation procedures (XDT) 36-48 may be implemented individually within the XSLM Translator 20, as a separate runtime library of procedures that may be executed as necessary by the appropriate API calls, as an external agent process that is similarly invoked, or by an interceptor 34 for intercepting ILM API calls. See FIGS. 1B and 1C which depict some of these implementations.

In the latter instance, the XDT intercepts ILM API calls by “hooking” into the individual software products; by hooking into the ILM or, preferably by being implemented as a separate process wherein the executable modules of the XDT completely replace those of the ILM.

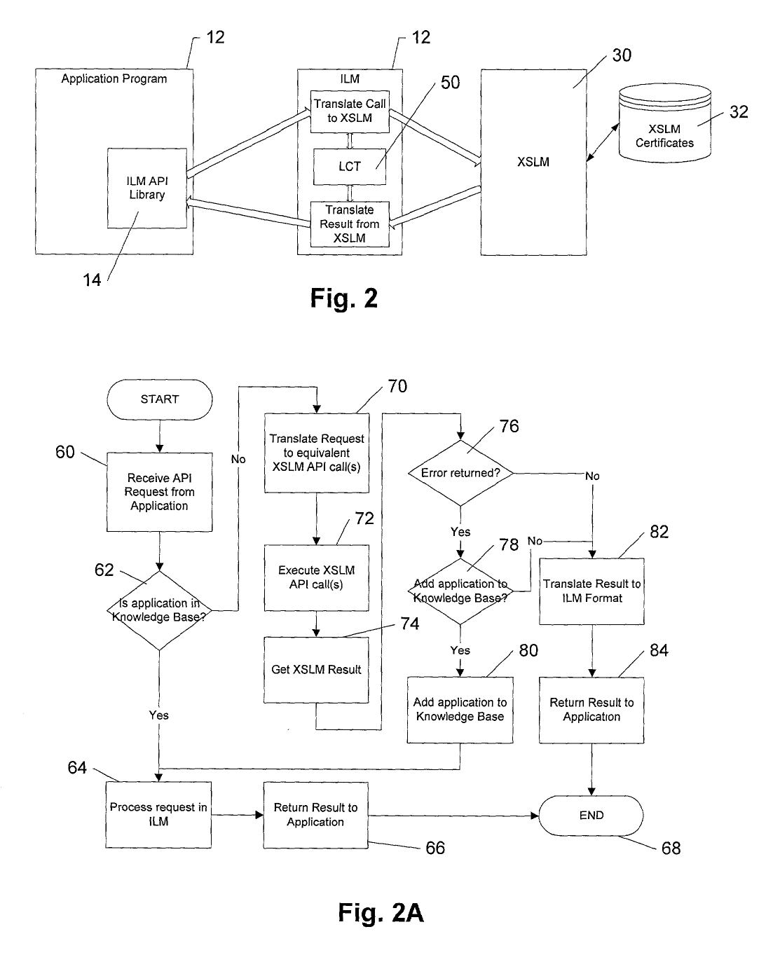

In another embodiment (FIG. 2), a License Certificate Translator (LCT) 50 is used in those instances wherein it is impractical to replace the ILM 12 with an XSLM translator 20—the number of software applications that would have to be re-linked are too numerous; there are legacy applications for which the link modules are no longer available; there are legacy applications that use services of the ILM which cannot be duplicated by the XDT 34-48; or an ILM vendor wants to use the license certificates and facilities of XSLM 30.

In this embodiment, translation of the license certificate from one format to another is an effective means. Referring to FIG. 2, the ILM 12 (i.e., the ILM license server) has incorporated within it two sets of procedures: one that contains the appropriate XSLM-API calls and a second set that contains the appropriate ILM-API calls, both of which make use of the LCT 50 to translate the data contained within an XSLM license to ILM format and vice versa. The LCT 50, which incorporates the same functionality as the XDT, translates and augments the data between all known ILM API data elements and XSLM API data elements in a manner completely transparent to both the licensed software applications 10 and the XSLM server 30.

When an application 10 makes a license request 60 in the normal manner to the ILM 12 (FIG. 2A), a first set of procedures 62 are invoked to determine if the LCT 50 is to be employed or if the request is to be processed in part or entirely by the ILM 64. Using a knowledge base—a database, file, table, list, etc.—of software products or by calls to ILM APIs that are only supported by the ILM, the ILM 12 first determines if requests by this product are to be processed directly by the ILM. If not, the LCT 50 processes the request. It translates the data from the ILM API to the format required for the XSLM API call(s) 72 and then makes the XSLM API call(s) 72 that corresponds to the original request. Any data that is returned by the XSLM API call 74 is then translated by a second set of procedures 76, 82 back into ILM format and returned to the calling application program 84, 68.

Typically, the ILM knowledge base is provided and maintained by the ILM vendor who may in turn extend this ability to the user. Optionally, the ILM dynamically populates and updates the knowledge base in a self-adaptive manner 78, 80. For example, when the ILM receives an API call from a product that is not listed in the knowledge base, it can choose to add that product to the knowledge base if any of the following criteria is met:

The product uses a prior version of API calls;

The product requires an ILM certificate that cannot be translated by the LCT;

Errors 76 in processing are returned by LCT;

Errors in processing are returned by the XSLM;

Etc.

If a product is dynamically added to the knowledge base, the ILM 12 processes the request even though the XSLM attempted to process that request 76, 78, 80 and 64 (FIG. 2A).

Typically, the LCT 50 is linked into the ILM 12 as object code; linked as a shared runtime library; or as an executing process that is accessed via its own set of API calls.

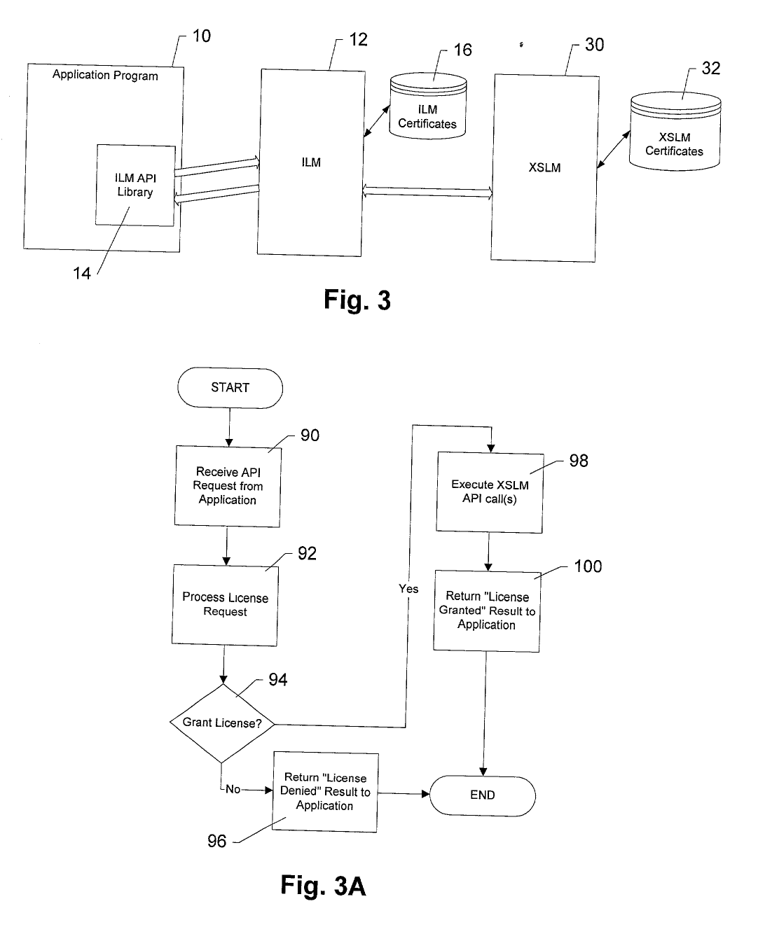

In yet another embodiment, the ILM 12 and XSLM 30 function as Dual License Managers. In some instances it may be impractical or undesirable to make major modifications to the ILM to translate license certificates, however, the ILM vendor desires to use certain features of the XSLM 30. For example, the set of application API calls to the ILM are incompatible with those required for the XSLM or the ILM vendor desires to continue using the facilities embodied in the ILM such as data logging. Hence, in this embodiment, the ILM 12 and XSLM 30 operate together, each maintaining its own license certificates 16, 32 for the same application programs, which continue to directly use the license services of the ILM 12 (FIG. 3).

Modifications are made to the ILM server such that it only communicates license instance information, e.g. transactions, to the XSLM server. Instead of using a normal XSLM certificate, the application's license request 90 continues to be served by the same license certificate 16 that the ILM normally uses. When a license request 90 is made by an application program (FIG. 3A depicts the processing within the modified ILM), the ILM server processes that request as it would have before being modified 92. Additionally, the ILM communicates that information to the XSLM server 94, 98, 100 via the published XSLM APIs, such as “xslm_basic_request_license( )”, so that both servers maintain parallel sets of license instance information.

In this manner, the XSLM 30 is being kept informed by the ILM 12 of all issued licenses, hence, the customer can obtain license management information for both XSLM and ILM licenses using only the normal XSLM license tools, even though the ILM server is still running. Note that this method may utilize a “dummy” XSLM license certificate that always grants license requests 100, no matter what the actual terms and conditions are encoded in the ILM certificate; the only purpose of the XSLM license certificate 16 is for XSLM to maintain a parallel set of active licenses to those granted by the ILM.

In yet another embodiment, the ILM vendor uses the XSLM 30 as a repository for its own ILM-native format licenses. The XSLM specification provides within the XSLM license certificate a section for the express purpose of containing arbitrary application-related data in any machine readable format. Thus, for the XSLM to be used as a license repository, a tool must be provided (perhaps by the ILM vendor) to create an XSLM license certificate for each ILM licensed application and then insert within that certificate the ILM-native format license certificate that was originally created by the application vendor.

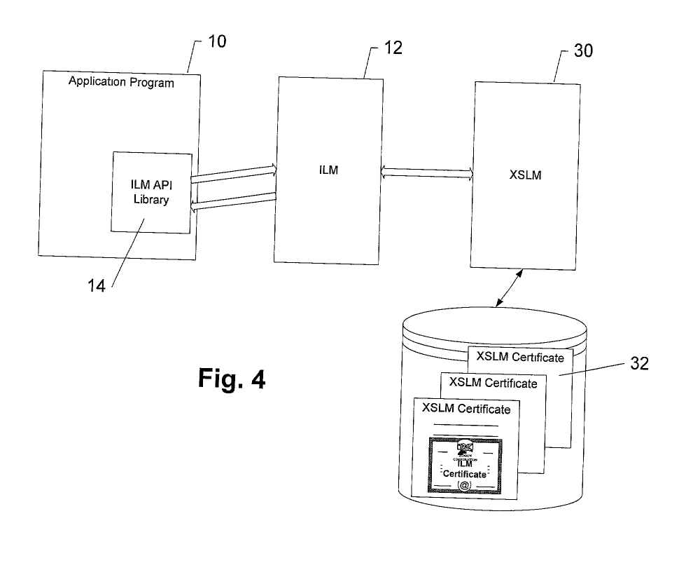

Referring to FIG. 4, when the ILM server 12 receives a license request from an application 10, it in turn makes the appropriate API calls to query the XSLM server, such as “xslm_get_certificate( )”, to obtain the embedded certificate information and make use of this to grant a license to the application program. In effect, the XSLM server acts as a repository of ILM license certificates, thus providing the user the convenience of using only one tool to manage license certificates for both the XSLM and the ILM systems.

Optionally, the ILM server 12 communicates license instance information to the XSLM server 30 (as described above) so that the XSLM system has a record of actual license usage and the user may use XSLM tools to manage license usage.

While the foregoing description has focused on instrumenting an LM to use the functionality and capabilities of an XSLM-compliant LM, the methods and techniques presented here are equally applicable to re-instrument the interface of any license manager to another license manager. For example, the methods described are equally applicable to the instance wherein an XSLM-compliant LM is instrumented to interface with another LM or even another XSLM, perhaps from another vendor.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A software license manager system, comprising:
a plurality of application programs;
a plurality of license certificates that authorize use of corresponding ones of the application programs;
license retrieval protocols associated with and operable by the application programs to request license authorizations, each of the protocols being associated and operable with a predetermined license manager; and
a second license manager operable to intervene and perform at least a portion of the functions otherwise performed by a plurality of the predetermined license managers.

2. The software license manager system of claim 1, in which the second license manager is operable transparently to the plurality of application programs.

3. The software license manager system of claim 1, in which the application programs include a facility that enables their selective operation with a predetermined license manager or with the second license manager.

4. The software license manager system of claim 1, in which the second license manager serves as a central license manager for substantially all of the application programs in a computer.

5. The software license manager system of claim 1, in which the second license manager serves to centralize and replace software operations normally performed by a plurality of predetermined license managers.

6. The software license manager system of claim 4, in which the license certificates are associated with, controlled and dispensed by the central license manager.

7. The software license manager system of claim 4, including a plurality of the predetermined license managers and the plurality of the predetermined license managers being operationally coupled with the central license manager.

8. The software license manager system of claim 1, including at least one predetermined license manager and the second license manager being operable to handle and store license use historical information.

9. The software license manager system of claim 8, in which the license certificates are associated with and directly controlled by the at least one predetermined license manager.

10. The software license manager system of claim 9, in which the at least one predetermined license manager is coupled to the second license manager and uses the second license manager as a repository for its license certificates.

11. The software license manager system of claim 1, in which the second license manager is operable by intercepting API (Application Program Interface) calls issued by the plurality of application programs.

12. The software license manager system of claim 11, in which the second license manager intercepts the API calls by carrying out a hooking process.

13. The software license manager system of claim 1, in which the second license manager intercepts API calls by renaming modules.

14. The software license manager system of claim 1, in which the second license manager intercepts an API call by executing exit routines.

15. The software license manager system of claim 1, in which the system is operable to obtain for the application programs license certificates without assistance from any predetermined license manager.

16. The software license manager system of claim 1, in which, where the predetermined license manager has an API library that is provided as a shared runtime library or an executing agent process, the second license manager replaces the API library of the predetermined license manager with a shared runtime library or agent process thereof.

17. The software license manager system of claim 1, in which the second license manager has a translator that includes a facility that provides data compatibility between itself and the protocols associated with a plurality of the predetermined license managers.

18. The software license manager system of claim 17, in which the facility of the second license manager is operable to provide one or more of the following functionalities:
(a) temporary data elements, if necessary, to contain translated data for use in API calls;
(b) data elements in a format of one or more tables, lists, files to retain relevant data elements for one or more of the predetermined license manager protocols or the second license manager and their status across multiple API calls;
(c) conversion tables between data variables; and
(d) aliases to enable the protocols of the predetermined license manager or the second license manager to reference the same data where the respective formats are different.

19. The software license manager system of claim 17, in which the second license manager comprises a plurality of data translations procedures that are implemented individually within a translator facility of the second license manager.

20. The software license manager system of claim 19, in which the plurality of data translation procedures are implemented:
(a) individually within the translator of the second license manager;
(b) as a separate runtime library of procedures that can be executed by API calls;
(c) as an external agent process; or
(d) by intercepting API calls of the predetermined license manager.

21. The software license manager system of claim 1, further including at least one predetermined license manager and including a license certificate translator that is operable for translating license certificates created for the predetermined license manager to license certificates that are compatible with license certificate formats associated with the second license manager and vice versa.

22. The software license manager system of claim 21, in which the license certificate translator has a first set of procedures that are invoked to determine if the license certificate translator is to be employed in whole or part.

23. The software license manager system of claim 22, in which the first set of procedures operate by reference to a knowledge base or by calls to application program interface calls of the predetermined license manager.

24. The software license manager system of claim 21, in which the license certificate translator is linked in part into the at least one predetermined license manager as an object code, as a shared runtime library, or as an executing process that is accessed via its own set of API calls.

25. The software license manager system of claim 1, including at least one predetermined license manager which operates with the second license manager as dual license managers.

26. The software license manager system of claim 25, in which the at least one predetermined license manager and the second license manager cooperate to use their respective license certificates.

27. The software license manager system of claim 1, in which the second license manager develops license management information.

28. The software license manager system of claim 1, including at least one predetermined license manager having a facility for making API calls to the second license manager to obtain license certificates.

29. The software license manager system of claim 28, in which the at least one predetermined license manager communicates license use data to the second license manager for storage therein.

30. The software license manager system of claim 28, in which the software license manager system operates without any predetermined license managers.
